(19) United States
(12) Patent Application Publication
(10) Pub. No.: US 2026/0136419 A1
(43) Pub. Date: May 14, 2026

(54) Method for Establishing a Bluetooth Low Energy Connection Between an End Terminal and a Vehicle in the Context of a Digital Key Infrastructure, and Control Device

(71) Applicant: Bayerische Motoren Werke Aktiengesellschaft, Muenchen (DE)

(72) Inventor: Alaa MOURAD, Muenchen (DE)

(21) Appl. No.: 19/383,952

(22) Filed: Nov. 10, 2025

(30) Foreign Application Priority Data
Nov. 11, 2024 (DE) 10 2024 132 897.5

(51) Int. Cl. H04W 76/15; H04W 4/40; H04W 4/80; H04W 72/0453

(52) U.S. Cl. CPC H04W 76/15; H04W 4/40; H04W 4/80; H04W 72/0453

(57) ABSTRACT

A method for establishing a Bluetooth low energy connection between an end terminal and a vehicle in the context of a digital key infrastructure includes transmitting an advertisement in a first frequency band and a second frequency band, wherein the second frequency band has a higher frequency, establishing a first connection in the first frequency band, scanning for an advertisement in the second frequency band and establishing a second connection in the second frequency band. A control device for carrying out the method is also provided.

### CROSS REFERENCE TO RELATED APPLICATION

This application claims priority under 35 U.S.C. §119 from German Patent Application No. DE 102024132 897.5, filed November 11, 2024, the entire disclosure of which is herein expressly incorporated by reference.

### BACKGROUND AND SUMMARY

The invention relates to a method for establishing a Bluetooth low energy connection between an end terminal and a vehicle in the context of a digital key infrastructure, and a control device for a vehicle for carrying out such a method.

Bluetooth low energy (BLE) has been established in the last few years as one of the leading technologies for wire-free communication in numerous applications. Thanks to its energy-efficient architecture and its capability of connecting devices to one another over short and medium distances, the BLE standard is widely used in various areas, for example, including in digital key architectures in end terminal-vehicle communication.

BLE uses the license-free ISM band 2.4 GHz for transmissions which, as a result, permits simple implementation and is additionally globally available. However, as a result of the growing number of end terminals which use this frequency band, this technology is increasingly encountering problems. The 2.4 GHz band is very highly congested nowadays, not only as a result of BLE applications but also of other communication systems such as WLAN, microwaves and other Bluetooth protocols. This increasingly leads to interference, disruption and reduced data transmission quality, in particular in highly frequented environments.

In order to ensure the performance and reliability of BLE, there is therefore a growing need for a technology which addresses this problem of frequency band congestion without significantly impairing the advantages of BLE. The present invention is based on the object of developing BLE further in such a way that it can be operated reliably in congested frequency environments.

This object is achieved by a method according to the independent method claim. The method according to the invention for establishing a Bluetooth low energy connection between an end terminal and a vehicle in the context of a digital key infrastructure comprises the following steps: transmitting an advertisement in a first frequency band and transmitting an advertisement in a second frequency band, wherein the second frequency band has a higher frequency than the first frequency band; establishing a first connection in the first frequency band; scanning for an advertisement in the second frequency band; establishing a second connection in the second frequency band. The first frequency band can be the existing frequency band at 2.4 GHz, while the second frequency band is located at a higher frequency.

The method provides that advertisements are firstly transmitted in both frequency bands. However, since the frequency band having the lower frequency generally has a greater range, a connection is generally initially established in the first frequency band. However, since this first frequency band is generally also the frequency band which has the greater congestion, this first connection is effectively used as a pilot connection for establishing the second connection in the second frequency band. In order to make this possible, following the establishment of the first connection in the first frequency band, the second frequency band is scanned for the advertisement. Both the transmission of advertisements and the scanning can then be carried out in the second frequency band. However, provision can also be made alternatively or additionally for information about the presence of the second frequency band to be provided on the existing first frequency band via advertisements and active scanning.

In practical terms, the method can provide for the second connection to be established in parallel with the first connection. Alternatively, the second connection can cancel the first connection after the second connection has been established. In this connection, it is of relevance what resources are available in the end terminal and the vehicle. If the end terminal is designed for dual-band operation, the second connection can be operated in the higher frequency band in parallel with the first connection. This has the advantage that overall higher data rates can be achieved in this way. On the other hand, if the resources are limited, it is expedient to cancel the first connection after the second connection has been established.

Preferably, the first frequency band is located at 2.4 GHz and the second frequency band in the region of 5-6 GHz. The frequency band at 5-6 GHz or above has the advantage that it permits higher data transmission rates and, overall, less interference occurs, since this band is currently less congested.

In an advantageous refinement of the invention, the second connection is established in the second frequency band if the distance between the end terminal and the vehicle falls below a specific minimum distance. The frequency band having the higher frequency generally has a shorter range with the same or comparable transmission power. The distance between the end terminal and the vehicle can be determined, for example via the signal strength or directly, via an existing first connection in the lower frequency range. If it is then determined that the distance between the end terminal and the vehicle falls below such a minimum distance, so that the second connection can be established without difficulty, this can be done.

Alternatively or additionally, provision can be made for the second connection in the second frequency band to be used if a higher data transmission rate is needed and/or if a higher battery output is available. In general, the frequency band having the higher frequency permits a higher data transmission rate but at the same time also generally needs a higher battery output from the end terminal. It is therefore advantageous if the second connection is established in particular if a higher data rate is desired and/or necessary. At the same time, this can be based on whether the end terminal can provide the higher transmission and receiving power for the frequency band having the higher frequency in the short and/or long term.

In a further refinement of the invention, provision can be made for the second connection in the second frequency band to be used if the first frequency band has a poor connection quality. If the first frequency band offers a sufficient connection quality (QoS), as a rule there is no need to change to the higher frequency band. However, if the signal quality begins to worsen or experience shows that this can be expected, a change can be made to the frequency band with the higher frequency in order to avoid or to compensate for a worsening in the transmission quality.

Preferably, a change from the first to the second connection and/or from the second connection to the first connection can be controlled dynamically by using criteria such as, for example, signal strength, data requirements, interference, distance between end terminal and vehicle and/or energy consumption. In this way, the stability and the quality of the connection can be optimized.

In a practical refinement of the invention, provision can be made for the scanning step to be carried out only if there is a need to establish the second connection. If, for example, the reason for establishing the connection has already disappeared after a short time with the establishment of the first connection, even before the second connection has been established, scanning for the second connection can be omitted.

The object is additionally achieved by a control device for a vehicle for carrying out one of the aforementioned methods.

The invention will now be explained with reference to the figure and by using an exemplary embodiment.

Other objects, advantages and novel features of the present invention will become apparent from the following detailed description of one or more preferred embodiments when considered in conjunction with the accompanying drawings.

### BRIEF DESCRIPTION OF THE DRAWINGS

The figure shows, in a schematic flow chart, an example of a method for establishing a Bluetooth low energy connection between an end terminal and a vehicle.

### DETAILED DESCRIPTION OF THE DRAWINGS

The figure illustrates an exemplary embodiment of a method for establishing a Bluetooth low energy connection between an end terminal 12 and a vehicle 14 in the context of a digital key infrastructure. In the exemplary embodiment shown in the figure, a user 10 is carrying a mobile end terminal 12 and wishes to gain access to the vehicle 14. For this purpose, it is necessary to establish a secure wire-free communication connection in order to be able to replace the corresponding digital key. Depending on the digital key infrastructure, this can be done – inter-alia – via a Bluetooth low energy connection. For this purpose, the user 10 moves the mobile end terminal 12 into the vicinity of the vehicle 14 symbolically in the first step S1.

The vehicle 14 has a control device 100 for carrying out the method steps explained below and, according to the BLE standard, transmits an advertisement at regular time intervals on each of the frequency bands available – here the frequency band FB1, frequency band FB2 (steps S2, S3). The first frequency band FB1 can be located in the known region of 2.4 GHz. The second frequency band FB2 has a higher median frequency and, for example, is located in the region of 5-6 GHz or above.

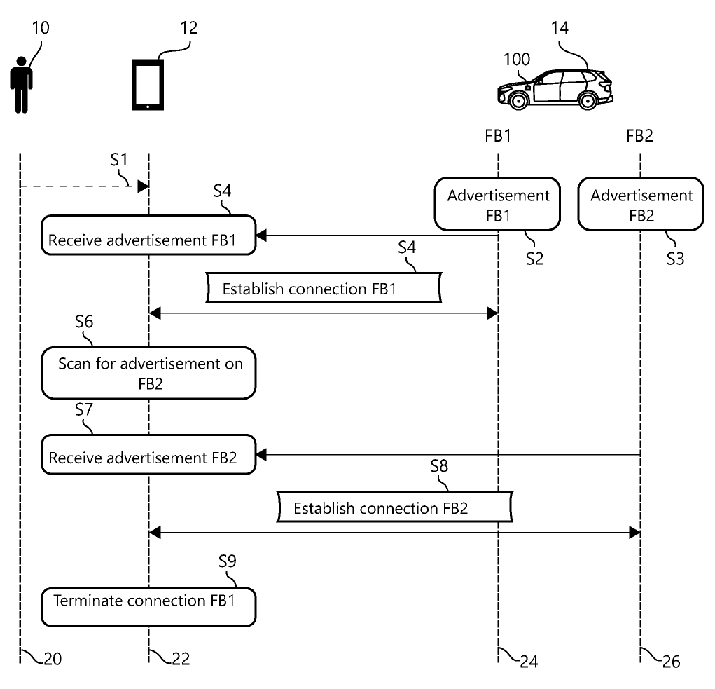

For the purpose of illustration of the time sequences, timelines 20-26 for the involved entities user 10, end terminal 12 and vehicle 14 are plotted in the figure. The time sequence is from top to bottom in FIG. 1. For improved clarity, two timelines 24, 26 for each of the frequency bands FB1 (timeline 24) and FB2 (timeline 26) involved in the method are shown for the vehicle 14. If the end terminal 12 is located sufficiently close to the vehicle 14, it is capable of receiving a first advertisement from the vehicle 14 in a first frequency band (FB1) in a step S4.

With the reception of the advertisement FB1, the intended first connection between the end terminal 12 and vehicle 14 can be established (step S5). After the connection in the frequency band FB1 has been established, the mobile end terminal 12 can scan for a further advertisement in the second frequency band FB2 (step S6). Since the mobile end terminal 12 is coming closer to the vehicle 14 and thus the distance between the vehicle 14 and the end terminal 12 is becoming smaller, after a certain amount of time the end terminal 12 will be in a position to receive a corresponding advertisement in the frequency band FB2 (step S7). When the advertisement in the frequency band FB2 has been received, the mobile end terminal 12 and vehicle 14 can establish a second connection in the frequency range FB2 (step S8).

With the existence of the second connection in the frequency range FB2, a decision can then be made, depending on the infrastructure, to terminate the first connection in the frequency range FB1. This is illustrated in step S9 in the figure. As a result, the second connection in the frequency range FB2 is maintained.

Alternatively, the termination of the first connection can be made dependent on whether dual-band operation is possible. Should this be set up and possible, the first connection can be maintained.

Furthermore, it should be mentioned that establishing the second connection FB2 in step S8 can be made dependent on whether the connection quality of the first connection FB1 falls below a minimum quality criterion or this is to be expected.

What is claimed is:

1. A method for establishing a Bluetooth low energy connection between an end terminal and a vehicle via a digital key infrastructure, the method comprising:
transmitting an advertisement in a first frequency band and a second frequency band, wherein the second frequency band has a higher frequency;
establishing a first connection in the first frequency band;
scanning for the advertisement in the second frequency band; and
establishing a second connection in the second frequency band.

2. The method according to claim 1, wherein the second connection is established in parallel with the first connection.

3. The method according to claim 1, wherein the second connection cancels the first connection.

4. The method according to claim 1, wherein the first frequency band is located at 2.4 GHz and the second frequency band is located at 5 GHz.

5. The method according to claim 2, wherein the first frequency band is located at 2.4 GHz and the second frequency band is located at 5 GHz.

6. The method according to claim 3, wherein the first frequency band is located at 2.4 GHz and the second frequency band is located at 5 GHz.

7. The method according to claim 1, wherein the second connection is established in the second frequency band based on a distance between the end terminal and the vehicle falling below a specific minimum distance.

8. The method according to claim 2, wherein the second connection is established in the second frequency band based on a distance between the end terminal and the vehicle falling below a specific minimum distance.

9. The method according to claim 3, wherein the second connection is established in the second frequency band based on a distance between the end terminal and the vehicle falling below a specific minimum distance.

10. The method according to claim 1, wherein the second connection in the second frequency band is used based on a need for a higher data transmission rate or based on a higher battery output being available.

11. The method according to claim 2, wherein the second connection in the second frequency band is used based on a need for a higher data transmission rate or based on a higher battery output being available.

12. The method according to claim 3, wherein the second connection in the second frequency band is used based on a need for a higher data transmission rate or based on a higher battery output being available.

13. The method according to claim 1, wherein the second connection in the second frequency band is used based the first frequency band having a poor connection quality.

14. The method according to claim 2, wherein the second connection in the second frequency band is used based the first frequency band having a poor connection quality.

15. The method according to claim 3, wherein the second connection in the second frequency band is used based the first frequency band having a poor connection quality.

16. The method according to claim 1, wherein a change from the first connection to the second connection or from the second connection to the first connection is controlled dynamically based on signal strength, data requirements, interference or energy consumption.

17. The method according to claim 2, wherein a change from the first connection to the second connection or from the second connection to the first connection is controlled dynamically based on signal strength, data requirements, interference or energy consumption.

18. The method according to claim 3, wherein a change from the first connection to the second connection or from the second connection to the first connection is controlled dynamically based on signal strength, data requirements, interference or energy consumption.

19. The method according to claim 1, wherein the scanning step is carried out based only on a determination that there is a need to establish the second connection.

20. A control device for a vehicle configured to carry out a method according to claim 1.
